(19) United States
(12) Patent Application Publication
(10) Pub. No.: US 2017/0204784 A1
(43) Pub. Date: Jul. 20, 2017

(54) SINGLE SUPPLY PORT ACTIVATED CONNECTING ROD FOR VARIABLE COMPRESSION RATIO ENGINES

(71) Applicant: BorgWarner Inc., Aubum Hills, MI (US)

(72) Inventor: Fenton O'SHEA, Groton, NY (US)

(21) Appl. No.: 15/327,770

(22) PCT Filed: Jul. 15, 2015
(86) PCT No.: PCT/US2015/040535

§ 371 Date: Jan. 20, 2017

Related U.S. Application Data
(60) Provisional application No. 62/028,438, filed on Jul. 24, 2014.

(51) Int. Cl. F02B 75/04; F15B 15/12; F16C 7/06

(52) U.S. Cl. CPC F02B 75/045; F16C 7/06; F15B 15/12

(57) ABSTRACT

An apparatus and method relating to a variable compression connecting rod system (10, 110) located in an internal combustion engine including a connecting rod (28, 128) having a piston-pin-receiving aperture defining a first longitudinal axis in a first end portion and a crank-pin-receiving aperture defining a second longitudinal axis in a second end portion (36), a hydraulically actuated eccentric rotor (52) rotatable about one of the first and second longitudinal axis in response to fluid pressure acting on expandable chambers (76a, 76b, 78a, 78b, 176a, 176b, 178a, 178b) defined between the rotor (52, 152) and the connecting rod (28, 128). A hydraulic actuation system (51, 151) including a fluid pressure actuated activation valve (58, 158), at least one check valve (62, 64), and a plurality of fluid passages (66, 66a, 66b, 66c, 66d, 166) in fluid communication with the expandable chambers (76a, 76b, 78a, 78b, 176a, 176b, 178a, 178b).

### FIELD OF THE INVENTION

The invention relates to internal combustion engines, and more particularly, to an internal combustion engine with a variable length connecting rod for varying a length of a stroke of a piston within a cylinder.

### BACKGROUND

An internal combustion engine can include at least one cylinder and a plurality of intake valves and exhaust valves for operation. An internal combustion engine can include four cycles or strokes including an intake stroke, a compression stroke, an ignition/combustion/power stroke, and an exhaust stroke. During the intake stroke, the intake valve is opened and a piston can travel away from a cylinder head allowing a fuel and air mixture to enter the combustion chamber of the cylinder. During the compression stroke, the intake valve can be closed and the piston can reciprocate back toward the cylinder head for compressing the fuel and air mixture. During the power stroke, the fuel and air mixture can be ignited for forming a high-pressure gas delivering power to force the piston away from the cylinder head of the cylinder and rotate a crankshaft. During the exhaust stroke, the exhaust valve can be opened and the piston can move back towards the cylinder head causing the combusted fuel/air mixture of the high-pressure gas to be emitted as exhaust. Generally, the distance traveled by the piston during the intake and compression cycles is the same distance as traveled by the piston during the power and exhaust cycles, such that the volume of all four cycles is equal. The compression ratio, or the ratio of the travel distance of the piston at the end of the intake stroke and the beginning of the compression stroke to the travel distance at the beginning of the intake stroke and the end of the compression stroke, is preferably 8:1. It can be desirable to alter the engine cycle such that the volume of the power and exhaust cycles is greater than the volume of the intake and compression cycles for increasing the efficiency of the engine. Varying the engine cycle can require varying the length of the distance between the piston and the crankshaft, allowing the reciprocating motion of the piston within the cylinder to change between a minimum distance and a maximum distance, and thus, changing the compression ratio. Current variable compression systems use connecting rods extending between the piston and the crankshaft or a crankpin associated with the crankshaft. The connecting rods can require additional linkage for effectively changing the length of the connecting rods or the distance between the piston and the crankshaft. Variable compression connecting rod systems have been disclosed in U.S. Pat. No. 8,602,002; U.S. Pat. No. 8,468,997; U.S. Pat. No. 8,371,263; U.S. Pat. No. 7,891,334; U.S. Pat. No. 7,814,881; U.S. Pat. No. 6,966,279; and U.S. Pat. No. 5,370,093.

### SUMMARY

It can be desirable to eliminate the additional linkage used in known variable compression system connecting rod assemblies. To overcome the limitation of current technology, a variable compression connecting rod system disclosed herein can include at least one internally located hydraulic eccentric rotary actuator rotatable between first and second angular positions providing a minimum length and a maximum length of the corresponding connecting rod for changing the effective distance between a piston pin and a crankpin of a crankshaft. The disclosed variable compression connecting rod system can include a connecting rod having a first end portion with a first aperture for connection with a piston pin and a second end portion with a second aperture for connection with a crankpin of a crankshaft. The connecting rod can extend between the first and second end portions.

A variable compression connecting rod system can include a piston pin defining a first longitudinal axis, a crankpin defining a second longitudinal axis, and a source of pressurized fluid. A connecting rod can have a first end associated with the piston pin and a second end located distally opposite the first end and associated with the crankpin. A hydraulically actuated eccentric rotor can be rotatable about at least one of the first and second longitudinal axes associated with at least one of the first and second end. The eccentric rotor can be operable in response to fluid communication with at least one expandable chamber defined between at least one vane of the eccentric rotor and the connecting rod for rotating the eccentric rotor between first and second angular positions. The eccentric rotor can be rotatable in response to fluid pressure action acting on the at least one vane for varying a length of the connecting rod between the first and second longitudinal axes. The variable compression rod system can include a hydraulic actuation system associated with the eccentric rotor in fluid communication between the source of pressurized fluid and the at least one expandable chamber. The hydraulic actuation system can include at least one activation valve, at least one check valve, and at least one fluid passage. The hydraulic actuation system can be located in the connecting rod for fluid communication between an eccentric rotor and the source of pressurized fluid.

A variable compression connecting rod system can include a piston pin defining a first longitudinal axis, a crankpin defining a second longitudinal axis, and a source of pressurized fluid. A connecting rod system can include a first end associated with the piston pin and a second end located distally opposite from the first end and associated with the crankpin. A hydraulically actuated eccentric rotor can be rotatable about at least one of the first and second longitudinal axes associated with at least one of the first and second end between first and second angular positions. The eccentric rotor can include a first vane and a second vane disposed on an exterior surface of the eccentric rotor. Each of the first and second vanes can define a first expandable chamber and a second expandable chamber located on opposite sides of the corresponding vane. The eccentric rotor can be rotatable in a clockwise direction and a counterclockwise direction in response to fluid pressure acting on the first and second vanes within the corresponding first and second expandable chamber. The eccentric rotor can have different radial distances aligned with a longitudinal axis of the connecting rod within in the first and second angular positions for varying the longitudinal length of the connecting rod between the first and second axes. At least one fluid conduit can be provided allowing fluid communication between the first and second expandable chamber and the source of pressurized fluid.

A method of assembling a variable compression connecting rod system can include forming a connecting rod to be mountable with respect to a piston pin and a crankpin. The connecting rod can include a first end associated with respect to the piston pin and a second end located distally opposite from the first end to be associated with the crankpin. The piston rod can include an eccentric-rotor-receiving aperture formed therein. The method can include inserting at least one hydraulically actuated eccentric rotor within the eccentric-rotor-receiving aperture to be rotatable about at least one of the first and second longitudinal axes associate with at least one of the first and second ends between first and second angular positions. The eccentric rotor can be operable in response to fluid communication with at least one expandable chamber defined between at least one vane of the eccentric rotor and the connecting rod for rotating the eccentric. The eccentric rotor can have different radial distances movable into alignment with a longitudinal axis of the connecting rod in response to fluid pressure action acting on the at least one vane for varying the longitudinal length of the connecting rod between the first and second longitudinal axes. The hydraulic actuation system can be in fluid communication between a source of pressurized fluid and the at least one expandable chamber formed between the eccentric rotor and the connecting rod. The hydraulic actuation system can include at least one activation valve, at least one check valve, and at least one fluid passage. The method can further include mounting the eccentric rotor with respect to the eccentric-rotor-receiving aperture of the connecting rod for rotation. The method can include forming at least one fluid passage in the connecting rod.

A method is disclosed for operating a variable compression connecting rod system for an internal combustion engine having a piston pin defining a first longitudinal axis, a crankpin of a crankshaft defining a second longitudinal axis, and a source of pressurized fluid. The variable compression connecting rod system can include a connecting rod having a first end associated with the piston pin and a second end associated with the crankpin, and a hydraulically actuated eccentric rotor associated with at least one of the first and second end. The variable compression connecting rod system can be operable in response to fluid communication with at least one expandable chamber defined between at least one vane of the eccentric rotor and the connecting rod. The method can include pressurizing fluid through at least one fluid passage for fluid communication between the source of pressurized fluid and the at least one expandable chamber, selectively communicating at least one check valve between the source of pressurized fluid and the at least one expandable chamber, pressurizing the at least one expandable chamber for rotating the eccentric rotor in clockwise and counterclockwise rotation for varying an effective distance between the first and second longitudinal axis, and selectively communicating an activation valve allowing pressurized fluid to flow with respect to the at least one expandable chamber.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a cross sectional simplified schematic view of a variable compression connecting rod system illustrating a connecting rod having a first end associated with a piston pin and a second end associated with a crankpin, where the first end supports a hydraulically actuated eccentric rotor for movement between a first angular position and a second angular position to change an effective length of the connecting rod, and showing an activation valve in a first position allowing pressurized fluid communication between a source of fluid pressure and a first set of expandable chambers to rotate the eccentric rotor in a clockwise direction;

FIG. 2 is the schematic of FIG. 1 showing the activation valve in a second position allowing pressurized fluid communication between the source of fluid pressure and a second set of expandable chambers to rotate the eccentric rotor in a counterclockwise direction;

FIG. 3 is a perspective cross sectional view of the connecting rod with a sealing cover removed;

FIG. 4 is a cross sectional simplified schematic view illustrating a hydraulic actuation system having a control valve located outside of the connecting rod with fluid passages extending through the connecting rod and crankpin for fluid communication with the expandable chambers and showing the control valve in a first position with the eccentric rotor rotated in a clockwise direction;

FIG. 4A is a cross sectional, simplified schematic, detail view illustrating fluid passages of the connecting rod of FIG. 4 extending through the crankpin and the connecting rod with the fluid passages and annular grooves spaced axially from one another along a longitudinal axis of the crankpin;

FIG. 5 is a cross sectional simplified schematic view of the connecting rod of FIG. 4 showing the control valve in a second position with the eccentric rotor rotated in the counterclockwise direction; and

FIG. 6 is a cross sectional simplified schematic view of a connecting rod and hydraulic actuation system illustrating the eccentric rotor rotatable about a longitudinal axis associated with a crankpin and a hydraulic actuation system located external of the connecting rod with fluid passages extending through the crankpin and eccentric rotor for movement between the first and second angular positions.

### DETAILED DESCRIPTION

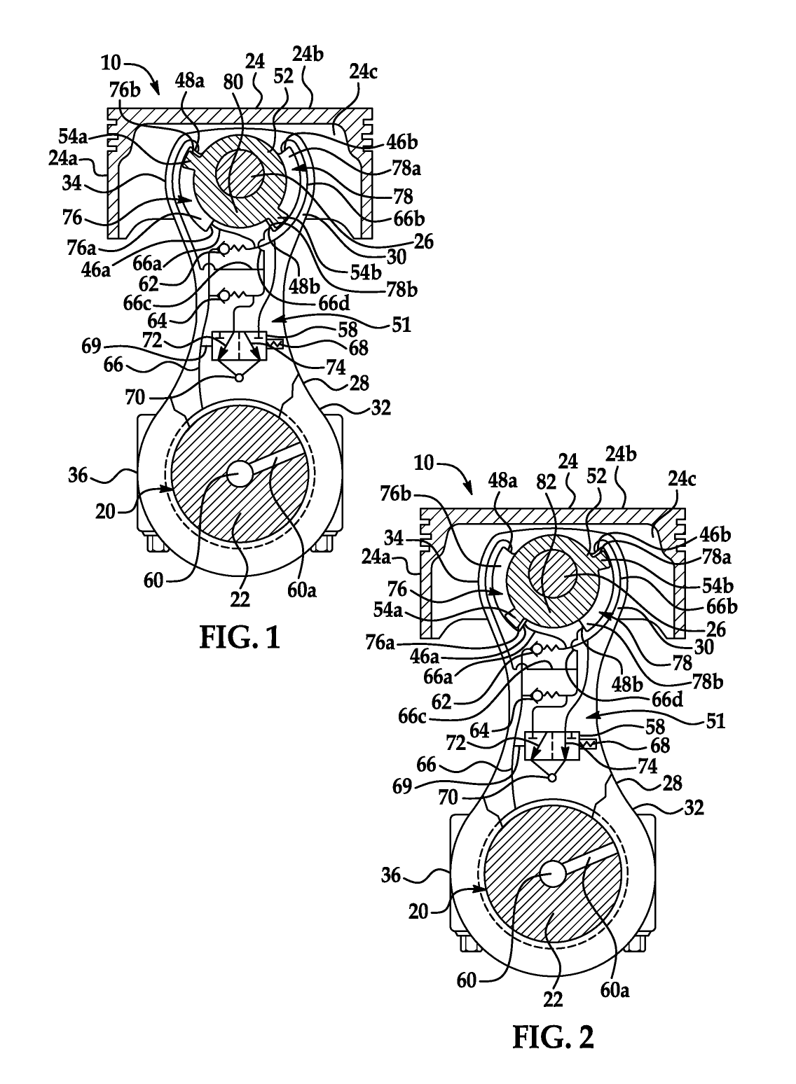

Referring now to FIGS. 1-5, a variable compression connecting rod system 10, 110 can include a connecting rod 28, 128 having a first end portion 34, 134 operably coupled to a piston pin 26 and a second end portion 36, 136 operably coupled to a crankpin 22 of a crankshaft 20. A hydraulically actuated eccentric rotor 52, 152 can be associated with at least one of the first and second end portions 34, 36, 134, 136. A hydraulic actuation system can include an activation valve 58, 158, a first check valve 62, 162 and second check valve 64, 164, and a plurality of fluid passages 66, 166. The disclosed variable compression connecting rod system 10, 110 can be used in an internal combustion engine. The internal combustion engine can include a reciprocating piston internal combustion engine. The engine can include at least one cylinder. By way of example and not limitation, the engine can include two, four, six, or eight cylinders. The engine can have any number of cylinders as known to those skilled in the art. The at least one cylinder can include a two-stroke operation, a four-stroke operation, or any number of strokes as known to those skilled in the art. The engine can include at least one piston 24 corresponding to the at least one cylinder. The engine can include a plurality of bearings for receiving a crankshaft 20, such that the crankshaft 20 can rotate relative to the engine. The crankshaft 20 can include a plurality of crank counterweights for providing rotational balance of the crankshaft 20 when assembled. The at least one piston 24 can be operably coupled to the crankshaft 20 through a connecting rod 28. The at least one piston 24 can include a head surface 24b, an underside surface 24c, and a piston skirt 24a. The head surface 24b can face a location where fuel is combusted in a combustion chamber defined by the at least one cylinder. The at least one cylinder and the underside surface 24c can be located distally opposite the head surface 24b. The piston skirt 24a can connect the head surface 24b and the underside surface 24c and can be disposed adjacent a sidewall defining the at least one cylinder in the engine. The at least one piston 24 can include a piston pin 26 defining a first longitudinal axis and can be operable for reciprocal movement within the at least one cylinder during an engine stroke. The at least one piston 24 can vary a volume of the at least one cylinder by moving between a top and bottom of the at least one cylinder during an engine stroke.

Referring now to FIGS. 1-2, the connecting rod 28 can have a first end 30 associated with the at least one piston 24 and a second end 32 located distally opposite the first end 30 and associated with the crankshaft 20. The connecting rod 28 can define at least one fluid passage 66 extending between the first and second ends 30, 32. The connecting rod 28 can define a plurality of fluid passages 66a, 66b, 66c, 66d. The first and second end portions 34, 36 can be located at the first and second ends 30, 32 of the connecting rod 28, respectively. The first end portion 34 can be connected to a piston operable for reciprocal movement within the at least one cylinder and can define a first aperture for receiving the piston pin 26. The first end portion 34 can be reciprocated within the at least one cylinder for connected movement with the at least one piston 24 between the first and second end limits of travel. The second end portion 36 can define a second aperture. A connecting rod bearing can be mounted within the second aperture in the second end portion 36 for connection to a crankpin 22 of a crankshaft 20. A connecting rod bearing can be interposed between the connecting rod 28 and the crankpin 22. The crankpin 22 can define a second longitudinal axis. At least one fluid passage can be provided through the crankshaft 20 for fluid communication through the crankpin 22 with the at least one fluid passage 66 formed in the connecting rod 28. The second end portion 36 can be rotatable with respect to the crankpin 22. The hydraulically actuated eccentric rotor 52 can be associated with one of the first and second end portions 34, 36, or a separate rotor 52 can be provided for each of the first and second end portions 34, 36 if desired, to be rotatable about a corresponding one of the first and second longitudinal axes. The eccentric rotor 52 can be operable in response to fluid communication through at least one fluid passage located in engine block. The eccentric rotor 52 can have at least one vane 54a, 54b located on an exterior surface to define at least one chamber 76, 78 located between the connecting rod 28 and the eccentric rotor 52. Fluid communication between the at least one fluid conduit 48 and one expandable chamber portion 76a, 76b, 78a, 78b of the chambers 76, 78 can rotate the eccentric rotor 52 in a clockwise or counterclockwise direction in response to fluid pressure acting against the at least one vane 54a, 54b. The eccentric rotor 52 can have an eccentric surface area with different radial distances 80, 82, rotatable in response to fluid pressure acting on the at least one vane 54a, 54b for varying an effective length of the connecting rod thereby varying a distance between the first and second longitudinal axes between a minimum distance and a maximum distance.

The eccentric rotor 52 can include a first vane 54a and second vane 54b disposed on an exterior surface of the eccentric rotor 52. The first and second vanes 54a, 54b can be located between approximately 90° and approximately 180° apart, inclusive. By way of example and not limitation, as illustrated in FIGS. 1-2, the eccentric rotor 52 can be associated with a first end portion 34 and mounted for rotation with respect to a piston pin 26. A first and second chamber 76, 78 can be defined between the first end portion 34 and the eccentric rotor 52. Each of the first and second vanes 54a, 54b can be rotatable within a corresponding one of the first and second chambers 76, 78. The first and second vanes 54a, 54b can be rotatable to drive the rotor in a clockwise or counterclockwise direction. The eccentric rotor 52 can be rotated with respect to the first end portion 34 in a clockwise or counterclockwise direction between a first angular rotor position and a second angular rotor position. The first angular rotor position can be defined by a first radial distance 80 of the eccentric surface area of the eccentric rotor 52 rotated into a position aligned with a longitudinal axis of the connecting rod 28 to provide a minimum connecting rod length. The second rotor position can be defined by a second radial distance 82 of the eccentric surface area of the eccentric rotor 52 rotated into a position aligned with the longitudinal axis of the connecting rod 28 providing a maximum connecting rod length. The first and second radial distances 80, 82 of the eccentric rotor 52 can be rotatable in response to communication of fluid pressure with one of the expandable chamber portions 76a, 76b; 78a, 78b of the chambers 76, 78 for driving rotation of the eccentric rotor 52 by applying pressure to one side of the first and second vanes 54a, 54b. The first and second vanes 54a, 54b can be rotatable within one of the at least one chamber 76, 78 by fluid pressure within one expandable chamber side of the at least one chamber 76, 78, while the other side is in fluid communication with a passage 70 to discharge fluid into a fluid sump. By way of example and not limitation, as illustrated in FIG. 1 the connecting rod 26 can define a fluid conduit 48 extending between the first end portion 34 and a second end portion 36. The second end portion 36 can receive a connecting rod bearing for mounting the second end portion 36 to a crankpin 22 defined on the crankshaft 20. The crankpin 22 can include at least one fluid passage for fluid communication with the at least one fluid passage 66, 66a, 66b, 66c, 66d. Actuation of the eccentric rotor 52 can occur when fluid pressure communicates through the fluid passage 60, 60a defined in the crankshaft 20, through a first fluid passage 66, through second fluid passages 66a, 66b, 66c, 66d branching from the first fluid passage 66, and into one of the expandable chamber portions 76a, 76b, 78a, 78b of the at least one chamber 76, 78. The fluid passages 66a, 66b can correspond to the first expandable chambers 76a, 78a and the second fluid passages 66c, 66d can correspond to the second expandable chambers 76b, 78b. More than one fluid passage can extend between the first and second end 30, 32 of the connecting rod. The fluid pressure received by one expandable chamber side 76a, 76b; 78a, 78b of the at least one chamber 76, 78 can drive the eccentric rotor 52 in either a clockwise direction or a counterclockwise direction between the first and second angular positions of the eccentric rotor 52.

As illustrated in FIGS. 1-2, the connecting rod 28 can define a plurality of fluid passages 66 extending between a source of pressurized fluid 60 and the first or second pressurized fluid entrance 46a, 46b, 48a, 48b. As illustrated in FIGS. 1-2, the crankshaft 20 can include the source of pressurized fluid 60 and a fluid passage 60a for fluid communication between the source of pressurized fluid 60 and the plurality of fluid passages 66. The plurality of fluid passages 66 can be in fluid communication with first and second check valves 62, 64. The plurality of fluid passages 66 can selectively be in fluid communication with first and second pressurized fluid entrances 46a, 46b, 48a, 48b depending on a position of an activation valve 58. The first check valve 62 can provide fluid communication between fluid passages 66 and fluid passages 66a, 66b associated with the first pressurized fluid entrances 46a, 46b. The second check valve 64 can provide fluid communication between fluid passages 66 and fluid passages 66c, 66d associated with the second fluid entrance 48a, 48b. The first and second check valve 62, 64 can provide fluid communication of pressurized fluid to either the corresponding pressurized fluid entrance or prevent fluid communication while allowing pressurized fluid flow through the activation valve 58 to return fluid passage 70 ultimately leading to a fluid sump. The first and second check valve 62, 64 can include a spring and a ball member such that the ball member prevents backflow and the pressurized fluid can pass through the first and second check valve 62, 64 when the pressurized fluid overcomes a biasing force of the spring. The variable compression connecting rod system 10 can include a return passage 70 for discharging pressurized fluid from the at least one chamber 76, 78. Return passage 70 can be used for lubrication of various parts of the engine ultimately leading to a fluid sump for recirculation through the source of pressurized fluid 60. The source of pressurized fluid 60 can be a fluid pump drawing fluid from the fluid sump.

In operation, a source of pressurized fluid 60 can pump fluid through fluid passages 60, 60a toward the plurality of fluid passages 66, 66a, 66b, 66c, 66d located in the connecting rod 28. The first and second check valve 62, 64 can be in fluid communication with the source of pressurized fluid 60 through the plurality of fluid passages 66. When a first fluid pressure is supplied to the variable compression connecting rod system 10, the activation valve 58 can be spring biased by spring 68 toward the first position 72, as illustrated in FIG. 1. The first fluid pressure is of insufficient magnitude to overcome the force of biasing spring 68 and activation valve 58 is maintained in the first position as illustrated in FIG. 1. The first fluid pressure is of sufficient magnitude to overcome the biasing force of check valve 62 allowing pressurized fluid communication with the first expandable chambers 76a, 78a through passages 66a, 66b to drive the eccentric rotor clockwise as illustrated in FIG. 1, while the activation valve 58 provides fluid communication between the second expandable chambers 76b, 78b and the return passage 70. When the first fluid pressure overcomes the spring biasing force of the first check valve 62, the pressurized fluid can flow toward the first pressurized fluid entrances 46a, 46b of the first and second chamber 76, 78 through the fluid passages 66a, 66b. The activation valve 58 can prevent fluid communication of the pressurized fluid with the return passage 70. The pressurized fluid entering the first and second chamber 76, 78 at the first pressurized fluid entrance 46a, 46b can rotate the first and second vane 54a, 54b in a clockwise direction with respect to the first longitudinal axis. The first vane 54a can rotate in the first chamber 76 and the second vane 54b can rotate in the second chamber 78. During rotation of the first and second vanes 54a, 54b in the clockwise direction as illustrated in FIG. 1, the second pressurized fluid entrances 48a, 48b located at an opposite end of the first and second chambers 76, 78 can vent fluid pressure through the plurality of fluid passages 66c, 66d associated with the second check valve 64 through the activation valve 58 into fluid communication with the return passage 70.

When a second fluid pressure higher than the first fluid pressure is supplied to the variable compression connecting rod system 10 from the source of pressurized fluid 60, the second fluid pressure can overcome the biasing force of the spring 68 to move the activation valve 58 from the first position 72 toward the second position 74. The second fluid pressure is of sufficient magnitude to overcome the force of biasing spring 68 and activation valve 58 is shifted into the second position 74 as illustrated in FIG. 2. The second fluid pressure is also of sufficient magnitude to overcome the biasing force of check valve 64 allowing pressurized fluid communication with the second expandable chambers 76b, 78b through passages 66c, 66d to drive the eccentric rotor counterclockwise as illustrated in FIG. 2, while the activation valve 58 provides fluid communication between the first expandable chambers 76a, 78a and the return passage 70. When the second fluid pressure overcomes the spring biasing force of the second check valve 64, the pressurized fluid can flow toward the second pressurized fluid entrance 48a, 48b of the first and second chamber 76, 78. When in the second position 74, the activation valve 58 can prevent fluid communication between the second check valve 64 and the return 70 passage. The pressurized fluid entering the first and second chamber 76, 78 at the second pressurized fluid entrance 48a, 48b can rotate the first and second vane 54a, 54b in a counterclockwise direction with respect to the first longitudinal axis. The first vane 54a can rotate in the first chamber 76 and the second vane 54b can rotate in the second chamber 78. During counterclockwise rotation of the first and second vane 54a, 54b, the first pressurized fluid entrances 46a, 46b located at an opposite end of the first and second chamber 76, 78 can discharge fluid pressure through the plurality of fluid passages 66a, 66b associated with the first check valve 62 through the activation valve 58 into fluid communication with the return passage 70. Fluid pressure responsive actuation of the activation valve 58 through fluid passage 69 can provide for clockwise and counterclockwise rotation of the eccentric rotor 52, varying the effective distance between the piston pin 26 and the crankshaft 20 for providing variable compression within the engine.

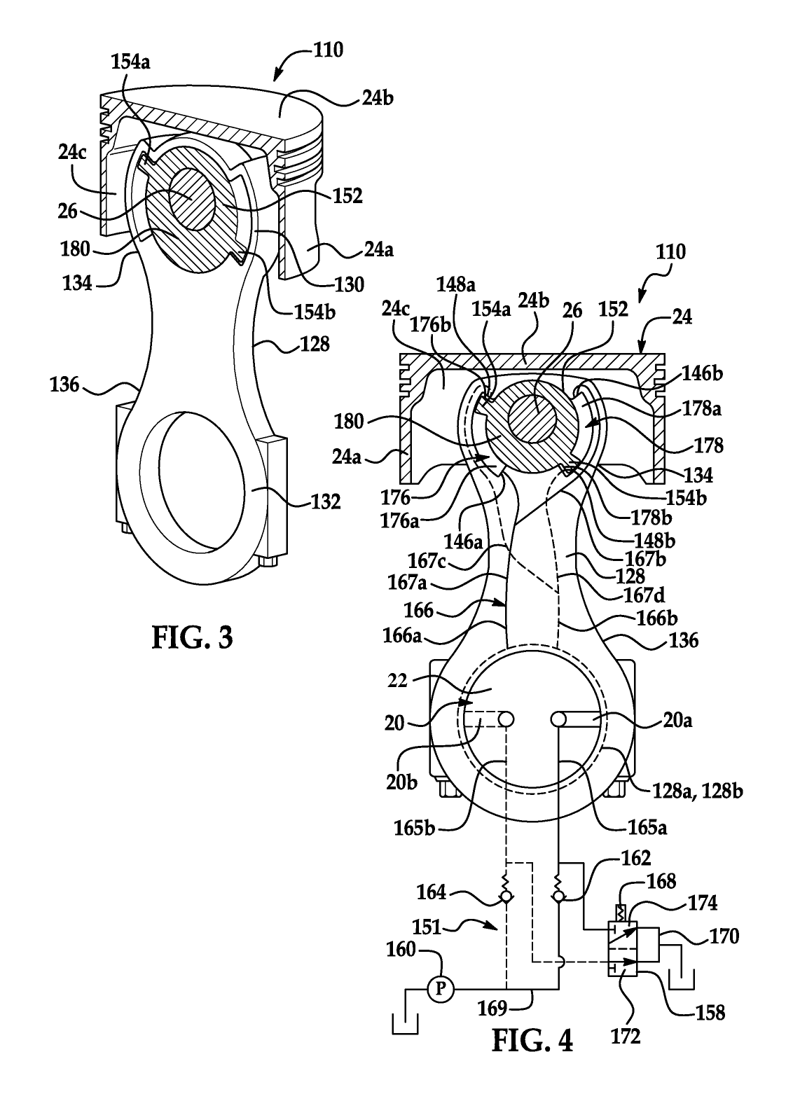

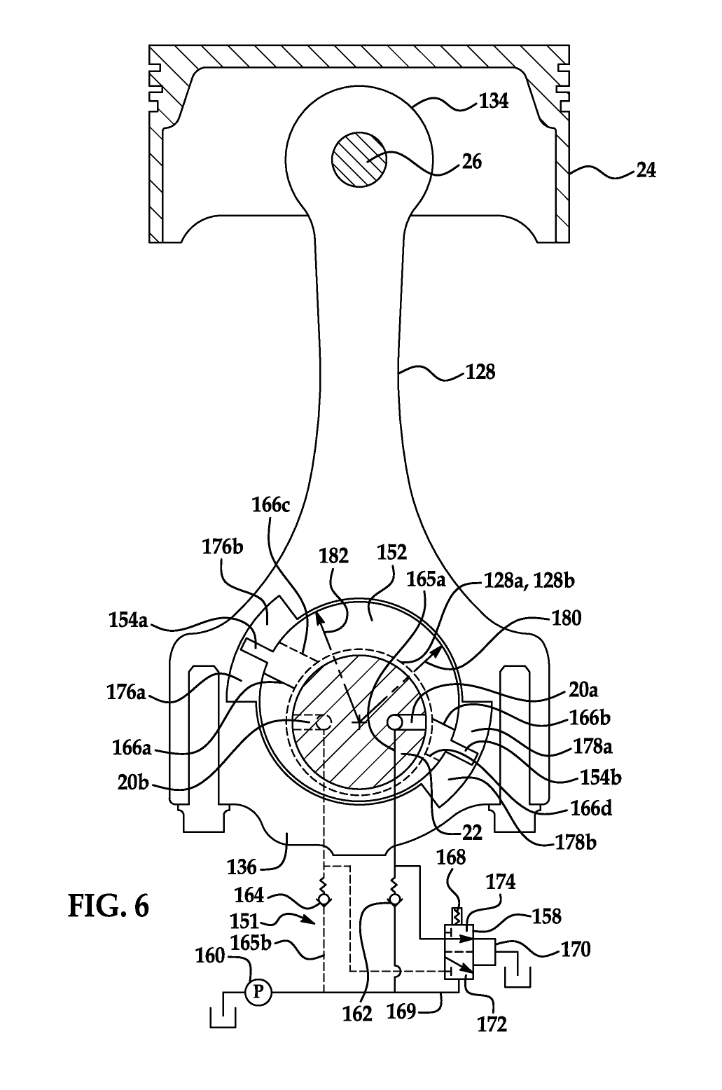

Referring now to FIGS. 3-5, the connecting rod 128 can include a first end 130 associated with the at least one piston 24 and a second end 132 located distally opposite the first end 130 associated with the crankshaft 20. At least one fluid passage 166, 166a, 166b, 167a, 167b, 167c, 167d can extend between the first and second ends 130, 132. The fluid pressure responsive activation valve 158 and check valves 162, 164 can be located outside of the connecting rod 128. The first and second end portions 134, 136 can be located at the first and second ends 130, 132 of the connecting rod 128, respectively. The first end portion 134 can be connected to a piston operable for reciprocal movement within the at least one cylinder and can define a first aperture for receiving the piston pin 26 defining a first longitudinal axis. The first end portion 134 can be reciprocated within the at least one cylinder for driving the at least one piston 24 between the first and second end limits of movement. The second end portion 136 can define a second aperture. A connecting rod bearing can mount the second end portion 136 to a crankpin 22 of a crankshaft 20. A connecting rod bearing can be interposed between the connecting rod 128 and the crankpin 22. The crankpin 22 can define a second longitudinal axis. At least one fluid passage can be provided through the crankshaft 20 for fluid communication through the crankpin 22 with the at least one fluid passage 166, 166a, 166b, 167a, 167b, 167c, 167d located inside of the connecting rod 128. The second end portion 136 can be rotatable with respect to the crankpin 22. The hydraulically actuated eccentric rotor 152 can be associated with one of the first and second end portions 134, 136, or a separate rotor 152 can be provided for each of the first and second end portions 134, 136 if desired, to be rotatable about a corresponding one of the first and second longitudinal axes. The eccentric rotor 152 can be operable in response to fluid communication through at least one fluid passage 165b, 165a in fluid communication with fluid passages 20a, 20b formed in the crankpin 22 of the crankshaft 20. The eccentric rotor 152 can have at least one vane 154a, 154b located on an exterior surface to define at least one chamber 176, 178 located between the connecting rod 128 and the eccentric rotor 152. Fluid communication between at least one fluid passage 166, 166a, 166b, 167a, 167b, 167c, 167d and one expandable chamber portion 76a, 76b, 78a, 78b of the chambers 76, 78 can rotate the eccentric rotor 52 in a clockwise or counterclockwise direction in response to fluid pressure acting against the at least one vane 154a, 154b. The fluid passages 167a, 167b can be in fluid communication with the first expandable chambers 176a, 178a, while the second fluid passages 167c, 167d can be in fluid communication with the second expandable chambers 176b, 178b. The fluid passages 167a, 167b, 167c, 167d can connect through the at least one fluid passage 166, 166a, 166b to be in fluid communication with the source of pressurized fluid 160. The eccentric rotor 152 can have an eccentric surface area with different radial distances 180, 182 (best seen in FIG. 6) rotatable in response to fluid pressure acting on the at least one vane 154a, 154b for varying the effective distance between the first and second longitudinal axes.

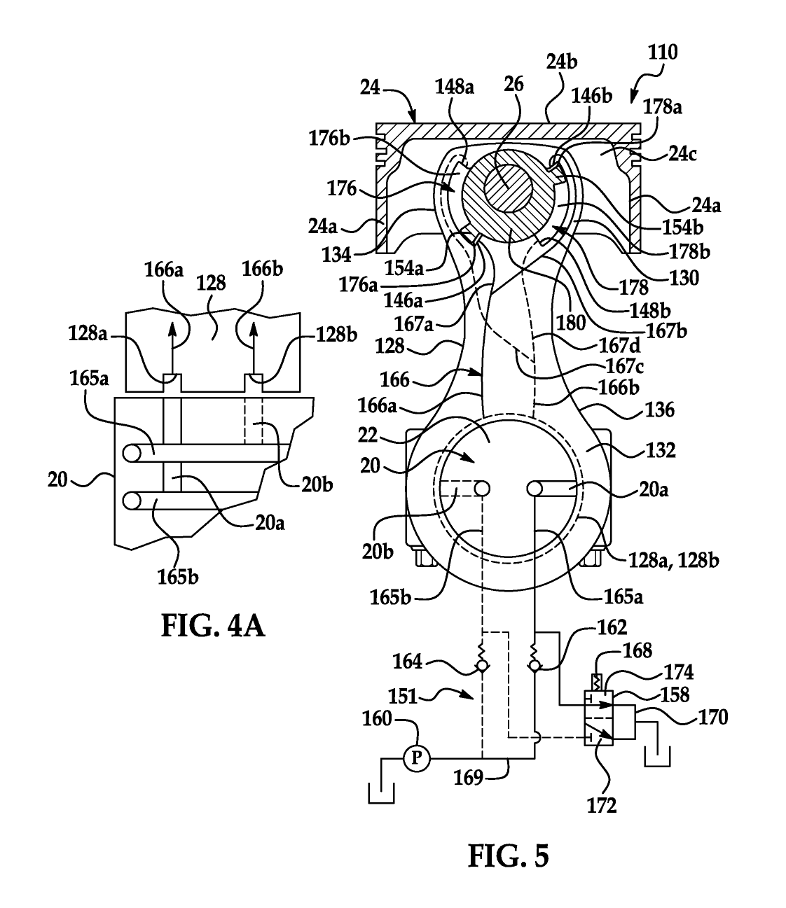

The eccentric rotor 152 can include a first vane 154a and a second vane 154b disposed on an exterior surface of the eccentric rotor 152. The first and second vanes 154a, 154b can be located between approximately 90° and approximately 180° apart, inclusive. By way of example and not limitation, as illustrated in FIGS. 4-5, the eccentric rotor 152 can be associated with a first end portion 134 and mounted concentrically with a piston pin 26. The first and second chambers 176, 178 can be defined in the first end portion 134 to receive the first and second vanes 154a, 154b of the eccentric rotor 152. Each of the first and second vanes 154a, 154b can be rotatable within a corresponding one of the first and second chambers 176, 178. The first and second vanes 154a, 154b can be rotatable to drive the rotor in a clockwise or counterclockwise direction. The eccentric rotor 152 can be rotated with respect to the first end portion 134 in a clockwise or counterclockwise direction between a first angular rotor position and a second angular rotor position. The first rotor position can be defined by a first radial distance 180 of the eccentric surface area of the eccentric rotor 152 rotated into a position to be aligned with a longitudinal axis of the connecting rod 128 to provide a minimum connecting rod length. The second rotor position can be defined by a second radial distance 182 of the eccentric surface area of the eccentric rotor 152 rotated into a position to be aligned with the longitudinal axis of the connecting rod 128 providing a maximum connecting rod length. The first and second radial distances 180, 182 of the eccentric rotor 152 can be aligned with respect to the longitudinal axis of the connecting rod 128 in response to communication of fluid pressure with one of the expandable chamber portions 176a, 176b; 178a, 178b of the chambers 176, 178 applying pressure to one side of the first and second vanes 154a, 154b for driving rotation of the eccentric rotor 152. The first and second vane 154a, 154b can be rotatable within one of the at least one chamber 176, 178 by fluid pressure within one expandable chamber side of the at least one chamber 176, 178, while the other side is in fluid communication to discharge into a return passage 170 ultimately leading to a fluid sump. The second end portion 136 can receive a connecting rod bearing for mounting the second end portion 136 to a crankpin 22 of a crankshaft 20. The crankpin 22 can include at least one fluid passage 165a, 165b, 20a, 20b for fluid communication with the at least one fluid passage 166, 166a, 166b, 167a, 167b, 167c, 167d. Actuation of the eccentric rotor 152 can occur when fluid pressure flows from the fluid passage defined in the crankpin, through a fluid passages 166, 166a, 166b, 167a, 167b, 167c, 167d into one of the expandable chamber portions 176a, 176b, 178a, 178b of the at least one chamber 176, 178. The hydraulic actuation system 151 can include fluid passages formed external of the connecting rod 128 and can extend into fluid communication with fluid passages 166, 166a, 166b, 167a, 167b, 167c, 167d extending between the first and second ends 130, 132 of the connecting rod 128. The fluid passages can be in fluid communication with at least one fluid passage 20a, 20b defined by the crankshaft 20. The fluid pressure received by one expandable chamber side 176a, 176b, 178a, 178b of the at least one chamber 176, 178 can drive the eccentric rotor 152 in either a clockwise direction or a counterclockwise direction between the first and second angular positions of the eccentric rotor 152.

As illustrated in FIGS. 3-5, the connecting rod 128 can define a plurality of fluid passages 166, 166a, 166b, 167a, 167b, 167c, 167d extending between a source of pressurized fluid 160 and the first and second pressurized fluid entrances 146a, 146b, 148a, 148b. The crankshaft 20 can include fluid passages 165a, 165b, 20a, 20b for fluid communication between the source of pressurized fluid 160 and the plurality of fluid passages 166, 166a, 166b 167a, 167b, 167c, 167d. FIG. 4A is a detailed schematic view illustrating the axial offset of fluid passages 20a, 20b in fluid communication with annular grooves 128a, 128b feeding fluid passages 166a, 166b of the connecting rod 128. The plurality of fluid passages 166, 166a, 166b 167a, 167b, 167c, 167d can provide fluid communication between the source of pressurized fluid 160 through the first and second check valve 162, 164 to communicate with the first and second pressurized fluid entrances 146a, 146b, 148a, 148b. The source of pressurized fluid is in fluid communication with a fluid pressure actuated activation valve 158 through passage 169. The first check valve 162 can provide fluid communication with the plurality of fluid passages 167a, 167b associated with the first pressurized fluid entrance 146a, 146b. The second check valve 164 can provide fluid communication with the plurality of fluid passages 167c, 167d associated with the second fluid entrance 148a, 148b. The first and second check valve 162, 164 can provide fluid communication of pressurized fluid to either the corresponding pressurized fluid entrance or prevent fluid communication while allowing pressurized fluid flow through the activation valve 158 to return fluid passage 170 ultimately leading to a fluid sump. The first and second check valve 162, 164 can include a spring and a ball member such that the ball member prevents backflow and the pressurized fluid can pass through the first and second check valve 162, 164 when the pressurized fluid overcomes a biasing force of the spring. The variable compression connecting rod system 110 can include a return passage 170 for discharging pressurized fluid from the at least one chamber 176, 178. Return passage 170 can be used for lubrication of various parts of the engine ultimately leading to a fluid sump for recirculation through the source of pressurized fluid 160. The source of pressurized fluid 160 can be a fluid pump drawing fluid from the fluid sump.

In operation, a source of pressurized fluid 160 can pump fluid through fluid passages 165a, 165b, 20a, 20b toward the plurality of fluid passages 166, 166a, 166b, 167a, 167b, 167c, 167d located in the connecting rod 128. The first and second check valve 162, 164 can be in fluid communication with the source of pressurized fluid 160 through the plurality of fluid passages 165a, 165b. When a first fluid pressure is supplied to the variable compression connecting rod system 110, the activation valve 158 can be spring biased by spring 168 toward the first position 172, as illustrated in FIG. 4. The first fluid pressure is of insufficient magnitude to overcome the force of biasing spring 168 and activation valve 158 is maintained in the first position as illustrated in FIG. 4. The first fluid pressure is of sufficient magnitude to overcome the biasing force of check valve 162 allowing pressurized fluid communication with the first expandable chambers 176a, 178a through passages 167a, 167b to drive the eccentric rotor clockwise as illustrated in FIG. 4, while the activation valve 158 provides fluid communication between the second expandable chambers 176b, 178b and the return passage 170. When the first fluid pressure overcomes the spring biasing force of the first check valve 162, the pressurized fluid can flow toward the first pressurized fluid entrances 146a, 146b of the first and second chamber 176, 178 through the fluid passages 167a, 167b. The activation valve 158 can prevent fluid communication of the pressurized fluid with the return passage 170. The pressurized fluid entering the first and second chamber 176, 178 at the first pressurized fluid entrance 146a, 146b can rotate the first and second vane 154a, 154b in a clockwise direction with respect to the first longitudinal axis. The first vane 154a can rotate in the first chamber 176 and the second vane 154b can rotate in the second chamber 178. During rotation of the first and second vanes 154a, 154b in the clockwise direction as illustrated in FIG. 4, the second pressurized fluid entrances 148a, 148b located at an opposite end of the first and second chambers 176, 178 can vent fluid pressure through the plurality of fluid passages 167c, 167d associated with the second check valve 164 through the activation valve 158 into fluid communication with the return passage 170.

When a second fluid pressure higher than the first fluid pressure is supplied to the variable compression connecting rod system 110 from the source of pressurized fluid 160, the second fluid pressure can overcome the biasing force of the spring 168 to move the activation valve 158 from the first position 172 toward the second position 174. The second fluid pressure is of sufficient magnitude to overcome the force of biasing spring 168 and activation valve 158 is shifted into the second position 174 as illustrated in FIG. 5. The second fluid pressure is also of sufficient magnitude to overcome the biasing force of check valve 164 allowing pressurized fluid communication with the second expandable chambers 176b, 178b through passages 167c, 167d to drive the eccentric rotor counterclockwise as illustrated in FIG. 5, while the activation valve 158 provides fluid communication between the first expandable chambers 176a, 178a and the return passage 170. When the second fluid pressure overcomes the spring biasing force of the second check valve 164, the pressurized fluid can flow toward the second pressurized fluid entrance 148a, 148b of the first and second chamber 176, 178. When in the second position 174, the activation valve 158 can prevent fluid communication between the second check valve 164 and the return 170 passage. The pressurized fluid entering the first and second chamber 176, 178 at the second pressurized fluid entrance 148a, 148b can rotate the first and second vane 154a, 154b in a counterclockwise direction with respect to the first longitudinal axis. The first vane 154a can rotate in the first chamber 176 and the second vane 154b can rotate in the second chamber 178. During counterclockwise rotation of the first and second vane 154a, 154b, the first pressurized fluid entrances 146a, 146b located at an opposite end of the first and second chamber 176, 178 can discharge fluid pressure through the plurality of fluid passages 167a, 167b associated with the first check valve 162 through the activation valve 158 into fluid communication with the return passage 170. The activation valve 158 is responsive to fluid pressure through fluid passage 169 to activate between the first and second positions in order to provide for clockwise and counterclockwise rotation of the eccentric rotor 152, varying the effective distance between the piston pin 126 and the crankpin 22 of the crankshaft 20 for providing variable compression within the engine. It should be recognized by those skilled in the art, that the activation valve 158 does not have to be a fluid pressure actuated activation valve when located external to the connecting rod 128 as shown in FIGS. 4-6. By way of example and not limitation, in an external configuration as illustrated in FIGS. 4-6, the activation valve 158 can be a solenoid operated valve, or any other known actuator operated configuration desired.

Referring now to FIG. 6, by way of example and not limitation, the eccentric rotor 152 can be associated with the second end 136 of the connecting rod 128 and mountable for rotation with respect to the crankpin 22. The eccentric rotor 152 can be rotatable with respect to the crankpin 22 and include first and second radial distances 180, 182 for varying the length between the first and second longitudinal axis of the piston pin 26 and the crankpin 22. As previously disclosed, the first and second vane 154a, 154b can be rotatable in clockwise and counterclockwise rotation within one of the at least one chamber 176, 178 by fluid pressure within one expandable chamber side of the at least one chamber 176, 178, while the other side is in fluid communication to discharge into a fluid sump for recirculation through the source of pressurized fluid 160. First fluid passages 167a, 167b can provide fluid communication with first expandable chambers 176a, 178a and second fluid passages 167c, 167d can provide fluid communication with second expandable chambers 176b, 178b. The fluid passages 167a, 167b, 167c, 167d can branch from the at least one fluid passage 166, 166a, 166b in fluid communication with the source of pressurized fluid 160. As illustrated in FIG. 6, the hydraulic actuation system 151 can include a fluid pressure actuated activation valve 158 responsive to fluid pressure through passage 169, and the first and second check valve 162, 164 can be located outside of the connecting rod 128.

A method for assembling a variable compression connecting rod system 10, 110 having a piston pin 26 defining a first longitudinal axis, a crankpin 22 of a crankshaft 20 defining a second longitudinal axis, and a source of pressurized fluid 60, 160 can include forming a connecting rod 28, 128 having a first end 30, 130 to be associated with the piston pin 26, a second end 32, 132 located distally opposite the first end 30, 130 to be associated with the crankpin 22, and at least one eccentric-rotor-receiving aperture associated with at least one corresponding longitudinal axis of the first and second axes. The method can include positioning a hydraulically actuated eccentric rotor 52, 152 having at least one vane 54a, 54b, 154a, 154b within the eccentric-rotor-receiving aperture for rotation about at least one of the first and second longitudinal axes associated with at least one of the first and second end 26, 32, 126, 132, and providing fluid passages for fluid communication with at least one expandable chamber 76a, 76b, 78a, 78b, 176a, 176b, 178a, 178b defined between the at least one vane 54a, 54b, 154a, 154b of the eccentric rotor 52, 152 and the connecting rod 28, 128. The method can further include providing a hydraulic actuation system 51, 151 for fluid communication between a source of pressurized fluid 60, 160 and the at least one expandable chamber 76a, 76b, 78a, 78b, 176a, 176b, 178a, 178b. The eccentric rotor 52 can be rotated between first and second angular positions in response to fluid pressure acting on the at least one vane 54a, 54b, 154a, 154b for varying a longitudinal length of the connecting rod 28, 128 between the first and second longitudinal axes.

The hydraulic actuation system 51, 151 can include at least one fluid pressure actuated activation valve 58, 158, at least one check valve 62, 64, 162, 164, and at least one fluid passage 66, 166. The method can further include mounting the eccentric rotor 52 at the first end 30 of the connecting rod 28 for rotation with respect to the piston pin 26, and forming at least one fluid passage 66, 66a, 66b, 66c, 66d in the connecting rod 28 in fluid communication with the at least one expandable chamber 76a, 76b, 78a, 78b, 176a, 176b, 178a, 178b. The method can further include mounting the eccentric rotor 152 at the second end 132 of the connecting rod 128 for rotation with respect to the crankpin 22, and forming at least one fluid passage 166, 166a, 166b, 166c, 166d inside of the eccentric rotor operably associated with the connecting rod 128 for fluid communication with the at least one expandable chamber 176a, 176b, 178a, 178b. The at least one fluid passage 166, 166a, 166b, 166c, 166d can be in fluid communication with the source of fluid pressure 160 through annular passages 128a, 128b formed in the eccentric rotor 152, radial passages 20a, 20b formed in the crankpin 22, and longitudinal passages 165a, 165b formed in the crankpin 22. The operation of the connecting rod 128 of FIG. 6 is the same as described with respect to FIGS. 4-5.

A variable connecting rod length can improve fuel efficiency by 5 percent to 10 percent. A variable connecting rod length can permit an internal combustion engine to be multi-fuel capable. A hydraulically actuated rotor mounted internally with respect to the connecting rod allows a hydraulic control system to use torsional energy to actuate, or to include a two-way control valve, or to include a multi-way control valve, or to include a spool valve having an internal check valve assembly as part of the hydraulic control system. No mechanical linkage is required to rotate the eccentric rotor mounted within the connecting rod. A hydraulic rotary actuator centered on-axis with the crankpin or piston pin bore is used to directly rotate the eccentric rotor in order to vary the effective length of the connecting rod between the two pin bores.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A variable compression connecting rod system (10, 110) having a piston pin (26) defining a first longitudinal axis, a crankpin (22) of a crankshaft (20) defining a second longitudinal axis, and a source of pressurized fluid (60, 160), the improvement comprising:
a connecting rod (28, 128) connectible between the piston pin (26) and the crankpin (22) and having an eccentric-rotor-receiving aperture formed relative to one of the first or second longitudinal axes;
an eccentric rotor (52, 152) having at least one vane (54a, 54b, 154a, 154b) engageable within the eccentric-rotor-receiving aperture for rotation about one of the first or second longitudinal axes, the eccentric rotor (52, 152) rotatable in response to fluid pressure in fluid communication with at least one expandable chamber (76a, 76b, 78a, 78b, 176a, 176b, 178a, 178b) defined between the at least one vane (54a, 54b, 154a, 154b) of the eccentric rotor (52, 152) and the connecting rod (28, 128); and
a hydraulic actuation system (51, 151) in fluid communication between the source of pressurized fluid (60, 160) and the at least one expandable chamber (76a, 76b, 78a, 78b, 176a, 176b, 178a, 178b) for rotating the eccentric rotor (52, 152) between first and second angular positions for varying a longitudinal length of the connecting rod (28, 128) between the first and second longitudinal axes.

2. The system of claim 1, wherein the eccentric rotor (52, 152) includes a first vane (54a, 154a) and a second vane (54b, 154b) disposed on an exterior surface of the eccentric rotor (52, 152), each of the first and second vanes (54a, 54b) defining a first and second expandable chamber (76a, 76b; 78a, 78b, 176a, 176b, 178a, 178b) located on opposite sides of the corresponding vane (54a, 54b, 154a, 154b), the eccentric rotor (52, 152) rotatable in a clockwise and counterclockwise direction in response to fluid pressure acting against the first and second vanes (54a, 54b, 154a, 154b) within the corresponding first and second expandable chambers (76a, 76b; 78a, 78b, 176a, 176b, 178a, 178b).

3. The system of claim 2, wherein the hydraulic actuation system (51, 151) includes a first check valve (62, 162) in fluid communication between the source of pressurized fluid (60, 160) and the first expandable chambers (76a, 78a, 176a, 178a) and a second check valve (64, 164) in fluid communication between the source of pressurized fluid (60, 160) and the second expandable chambers (76b, 78b 176b, 178b).

4. The system of claim 2, wherein the hydraulic actuation system (51, 151) includes a fluid pressure actuated activation valve (58, 158) operable between a first position (72, 172) and second position (74, 174), the activation valve allowing pressurized fluid flow with respect to the second expandable chambers (76b, 78b, 176b, 178b) when in the first position (72, 172) and allowing pressurized fluid flow with respect to the first expandable chambers (76a, 78a, 176a, 178a) when in the second position (74, 174).

5. The system of claim 1, wherein the eccentric rotor (52) is mounted for rotation with respect to the piston pin (26) within a first end (30) of the connecting rod (28, 128).

6. The system of claim 5 further comprising:
the fluid pressure activated hydraulic actuation system (51) formed in the connecting rod (28) extending between the first end (30) and the second end (32) with at least one fluid passage (66a, 66b, 66c, 66d, 166, 166a, 166b, 167a, 167b, 167c, 167d) formed in the connecting rod (28) for fluid communication with the at least one expandable chamber (76a, 76b, 78a, 78b).

7. The system of claim 1, wherein the eccentric rotor (52) is mounted for rotation with respect to the crankpin (22) within the second end (32) of the connecting rod (28, 128).

8. The system of claim 7 further comprising:
the hydraulic actuation system (151) formed at least partially external with respect to the connecting rod (128) with the at least one fluid passage (166, 166a, 166b, 167a, 167b, 167c, 167d) located internal with respect to the connecting rod (28, 128) in fluid communication between at least one fluid passage (20a, 20b) formed in the crankpin (22) of the crankshaft (20) and the at least one expandable chamber (176a, 176b, 178a, 178b).

9. A method for operating a variable compression connecting rod system (10, 110) comprising:
selectively supplying pressurizing fluid to at least one fluid passage (66, 166, 166a, 166b, 166c, 166d, 167a, 167b, 167c, 167d) for fluid communication between a source of pressurized fluid (60, 160) and at least one expandable chamber (76a, 76b, 78a, 78b, 176a, 176b, 178a, 178b) formed between an eccentric-rotor-receiving aperture formed in the connecting rod (28, 128) and a hydraulically actuated eccentric rotor (52, 152) mounted for rotation therein; and
rotating the eccentric rotor in response to pressurized fluid in fluid communication with the at least one expandable chamber (76a, 76b, 78a, 78b, 176a, 176b, 178a, 178b) defined between at least one vane (54a, 54b, 154a, 154b) of the eccentric rotor (52, 152) and the connecting rod (28, 128), the eccentric rotor rotatable between first and second angular positions in response to fluid pressure acting on the at least one vane (54a, 54b, 154a, 154b) for varying a longitudinal length of the connecting rod (28 128) between a minimum length and a maximum length of the connecting rod (28, 128).

10. The method of claim 9 further comprising:
biasing an activation valve (58, 158) toward a first position (72, 172) with a spring (68, 168), the first position (72, 172) allowing fluid communication between a second expandable chamber (76b, 78b, 176b, 178b) and a return passage (70, 170); and
actuating the activation valve (58, 158) toward a second position in response to fluid pressure greater than a spring biasing force for allowing fluid communication between a first expandable chamber (76a, 78a, 176a, 178a) and a return passage (70, 170).

11. The method of claim 10 further comprising:
supplying pressurized fluid to the first expandable chamber (76a, 78a, 176a, 178a) through a first check valve (62, 162) biased to open at a first pressure value;
supplying pressurized fluid to the second expandable chambers (76b, 78b, 176b, 178b) through a second check valve (64, 164) biased to open at a second pressure value greater than the first pressure value; and
discharging pressurized fluid from the first and second expandable chambers (76a, 76b, 78a, 78b, 176a, 176b, 178a, 178b) selectively through an activation valve (58, 158) in response to the first and second fluid pressure value, such that the second expandable chambers (76b, 78b, 176b, 178b) are in fluid communication with a return passage (70, 170) in response to the first pressure value and the first expandable chambers (76a, 78a, 176a, 178a) are in fluid communication with the return passage (70, 170) in response to the second pressure value.

12. The method of claim 9 further comprising:
selectively communicating pressurized fluid through an activation valve (58, 158) operable for switching between a first position (72, 172) and a second position (74, 174), the activation valve (58, 158) hydraulically actuating the eccentric rotor for rotation in a clockwise direction when in the first position and for rotation in a counterclockwise direction when in the second position.

13. A method for assembling a variable compression connecting rod system (10, 110) comprising:
forming a connecting rod (28, 128) having a first end (30, 130) to be associated with a piston pin (26) defining a first longitudinal axis, a second end (32, 132) located distally opposite the first end (30, 130) to be associated with the crankpin (22) defining a second longitudinal axis, and an eccentric-rotor-receiving aperture;
inserting an eccentric rotor (52, 152) having at least one vane (54a, 54b, 154a, 154b) within the eccentric-rotor-receiving aperture to be rotatable about at least one of the first or second longitudinal axes associated with one of the first or second end (26, 32, 126, 132), the eccentric rotor (52, 152) operable in response to fluid communication with at least one expandable chamber (76a, 76b, 78a, 78b, 176a, 176b, 178a, 178b) defined between the at least one vane (54a, 54b, 154a, 154b) of the eccentric rotor (52, 152) and the connecting rod (28, 128) for rotating the eccentric rotor (52, 152) between first and second angular positions, the eccentric rotor (52, 152) rotatable in response to fluid pressure action acting on the at least one vane (54a, 54b, 154a, 154b) for varying a longitudinal length of the connecting rod (28, 128) between the first and second longitudinal axes;
forming fluid passages forming a portion of a hydraulic actuation system (51, 151) for fluid communication between a source of pressurized fluid (60, 160) and the at least one expandable chamber (76a, 76b, 78a, 78b, 176a, 176b, 178a, 178b).

14. The method of claim 13, further comprising:
mounting the eccentric rotor (52) at the first end (30) of the connecting rod (28) for rotation with respect to the piston pin (26); and
forming at least one fluid passage (66, 66a, 66b, 66c, 66d) in the connecting rod (28) in fluid communication with the at least one expandable chamber (76a, 76b, 78a, 78b).

15. The method of claim 13, further comprising:
mounting the eccentric rotor (152) at the second end (132) of the connecting rod (128) for rotation with respect to the crankpin (22); and
forming at least one fluid passage (166, 167a, 167b, 167c, 167d) through the eccentric rotor (58, 158) in fluid communication with the at least one expandable chamber (176a, 176b, 178a, 178b).
